(19) United States
(12) Patent Application Publication
(10) Pub. No.: US 2024/0154997 A1
(43) Pub. Date: May 9, 2024

(54) TOR-BASED MALWARE DETECTION

(71) Applicant: Qatar Foundation for Education, Science and Community Development, Doha (QA)

(72) Inventors: Priyanka Dodia, Doha (QA); Mashael Al Sabah, Doha (QA)

(21) Appl. No.: 18/387,937

(22) Filed: Nov. 8, 2023

Related U.S. Application Data
(60) Provisional application No. 63/423,700, filed on Nov. 8, 2022.

(51) Int. Cl. H04L 9/40; G06N 20/00

(52) U.S. Cl. CPC H04L 63/145; G06N 20/00; H04L 63/1425

(57) ABSTRACT

A machine learning model for classifying encrypted traffic as benign or malicious without having to decrypt the traffic is provided that used traffic patterns from network logs to classify the traffic based on learned patterns for malware, and is capable of identifying zero-day malware is provided via: extracting encrypted traffic from communication logs for a network; identifying, from the encrypted traffic, while still encrypted, traffic patterns for users of the network; and classifying, via a machine learning model, the encrypted traffic as benign traffic or malicious traffic without decrypting the encrypted traffic according to the traffic patterns identified.

### CROSS-REFERENCES TO RELATED APPLICATIONS

The present disclosure claims the benefit of U.S. Provisional Patent Application No. 63/423,700 entitled “TOR-BASED MALWARE DETECTION” and filed on Nov. 8, 2022, which is incorporated herein by reference in its entirety.

### TECHNICAL FIELD

The present disclosure relates to a software tools or identifying and quantifying malware or other malicious content sent over encrypted network communication without needing to decrypt those communications.

### SUMMARY

The present disclosure provides new and innovative systems and methods for identifying and quantifying malware or other malicious content sent over encrypted network communication without needing to decrypt those communications. An artificial intelligence (AI) agent is provided that uses traffic analysis patterns to distinguish malicious from benign traffic.

The Onion Router (often referred to as Tor or TOR) is the most widely used anonymous communication network; having millions of daily users. Because Tor provides server and client anonymity, hundreds of malware binaries found in the wild rely on Tor to hide the presence of malware on a machine, and hinder Command & Control (C&C) takedown operations. Effective traffic analysis approaches that can accurately identify Tor-based malware communication are provided herein that preserve the benefits of anonymity and privacy offered by Tor, but allow for the identification of malicious traffic.

In various aspects, a method, a system for performing the method, and various goods produced by the method are provided. In various aspects, the method includes: extracting encrypted traffic from communication logs for a network; identifying, from the encrypted traffic, while still encrypted, traffic patterns for users of the network; and classifying, via a machine learning model, the encrypted traffic as benign traffic or malicious traffic without decrypting the encrypted traffic according to the traffic patterns identified.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates operation of transmissions over a Tor-based network, according to embodiments of the present disclosure.

FIG. 2 is a flowchart of an example method for Tor-based malware detection, according to embodiments of the present disclosure.

FIG. 3 illustrates a computing device, according to embodiments of the present disclosure.

### DETAILED DESCRIPTION

The present disclosure provides new and innovative systems and methods for identifying and quantifying malware or other malicious content sent over encrypted network communication without needing to decrypt those communications. An artificial intelligence (AI) agent is provided that uses traffic analysis patterns to distinguish malicious from benign traffic.

The Onion Router (often referred to as Tor or TOR) is the most widely used anonymous communication network; having millions of daily users. Because Tor provides server and client anonymity, hundreds of malware binaries found in the wild rely on Tor to hide the presence of the malware on a machine, and hinder Command & Control (C&C) takedown operations. Effective traffic analysis approaches that can accurately identify Tor-based malware communication are provided herein that preserve the benefits of anonymity and privacy offered by Tor, but allow for the identification of malicious traffic.

Malware-infected machines often need to connect to external servers to communicate with their C&C, fetch ransomware payment pages, or download files needed for their operations. Such malware can hide such activities and evade detection by exploiting the client- and server-side anonymity guarantees provided by Tor. With the hundreds of Tor-based malware being launched in the wild on a daily basis, there is an increasing need to detect such malware. This will not only protect enterprise hosts from the growing threat, but will also rid the Tor network from the overload of bots; improving traffic throughput for legitimate users of the Tor network through bandwidth-constrained exit nodes.

Traffic analysis is a promising approach to address the problem of Tor-carried malware. Traffic analysis is the process of examining traffic patterns (packet sizes, directions, timings, etc.) to infer more (sensitive) information about traffic, thereby reducing the expected privacy provided by encryption or by proxy-based anonymization. In the area of anonymous communication, traffic analysis has shown success in a wide range of applications, mostly related to censorship (detecting obfuscated communication) and privacy attacks. For example, Website Fingerprinting (WF) can identify a webpage visited by a Tor client only by using supervised machine learning classifiers pre-trained with traffic features extracted from prior visits to the same webpage.

In the realm of malware detection, traffic analysis has different design goals that introduce new challenges. In WF, for example, traffic analysts may not be interested in identifying uncensored pages, whereas this sort of detail is of interest to detect zero-day malware. Second, creating large-scale groundtruth datasets of real malware connections is significantly more challenging than other domains. Another fundamental challenge for malware detection is the need to differentiate between benign and malicious Tor connections so as to not interrupt the use of Tor for legitimate users.

The present disclosure therefore provides a first traffic analysis approach to defend against Tor-based malware that can accurately differentiate between benign and malicious encrypted Tor connections. More importantly, this approach can be applied to detect “zero-day” malware variants, which have not been seen by the models, which is achieved by applying traffic analysis techniques on encrypted malware traffic and logs. By using Tor-based malware exhibits execution or connection patterns that deviate from legitimate or benign Tor-based browser use, the analysis of encrypted traffic patterns can automate the identification of such malware.

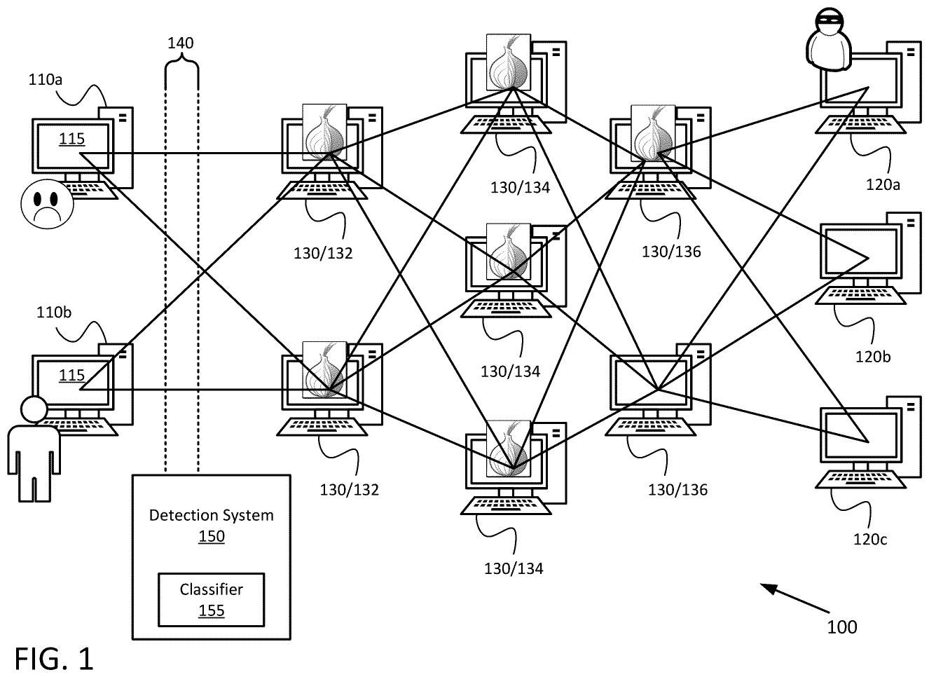

FIG. 1 illustrates operation of transmissions over a Tor-based network 100, according to embodiments of the present disclosure. Various clients 110 may access a Tor network 100 using a Tor browser, which runs the Onion Proxy (OP) 115 behind a modified internet browser. OPs 115 tunnel users' traffic to various destinations 120 through circuits, which are paths consisting of (at least) three Onion Routers (ORs) 130 that are volunteer operated computing systems from all over the world. The three ORs 130 in a circuit are known as the entry guard 132, middle 134, and exit 136. ORs 130 and OPs 115 share the network information including the OR names, internet protocol (IP) addresses, connection ports, public keys, and other information through a router consensus document. Using the public keys in the consensus, ORs 130 establish transmission control protocol (TCP) connections secured by transport layer security (TLS), and each connection multiplexes multiple circuits. Tor sends data in fixed-sized onion-encrypted units known as cells. A detection system 150, including a classifier 155 to identify malicious or benign traffic, is deployed between the clients 110 and the entry guards 132 (e.g., at an edge of a local network or exit port of a client 110).

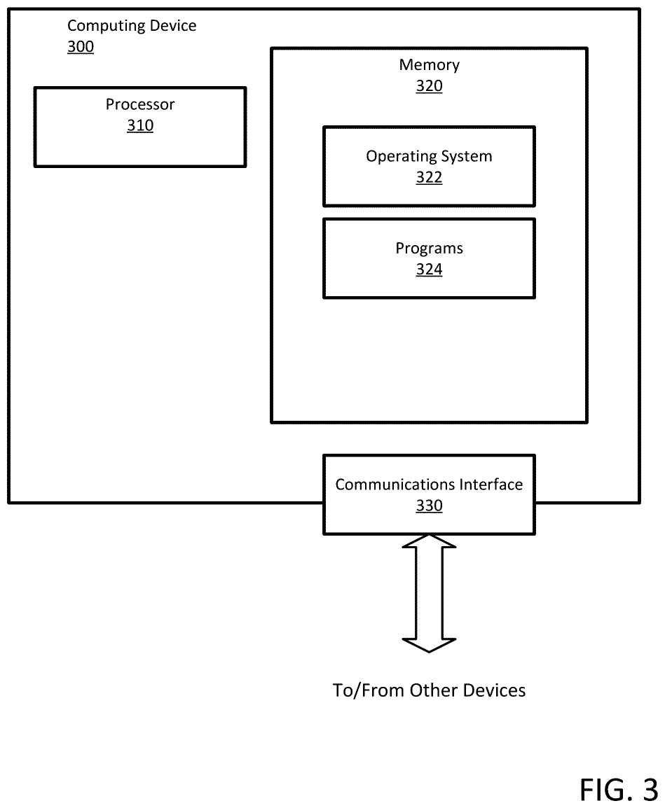

Each of the clients 110, destinations 120, ORs 130, and detection system 150 may be hosted by various computing devices, such as computing device 300 discussed in relation to FIG. 3.

Tor also provides server anonymity, which is known as onion or hidden services (HS). In this process, a user can deploy a server and serve content without revealing an IP address or location. Onion domain names appear random and end with “.onion”. Many legitimate popular domains such as facebook, duckduckgo, and wikileaks operate as HS. However, the anonymity provided by HS also makes HS attractive for malware as a hideout for C&C servers, which hinders takedown operations. As shown in FIG. 1, Tor-based malware connects to C&C servers through a 3-hop exit circuit if the external server is deployed on a publically accessible machine, or through 6-hop HS circuits (e.g., traversing the network 100 twice) if the external server is hosted as a hidden or onion service. This anonymity allows malware on an infected client 110a to obscure communications with a C&C server or other destination 120a operated by a malicious party, as a user of a healthy client 110b may route traffic through the same OR 130 to reach a legitimate destination 120b/120c.

For a user or malware to reach HS, either an OP 115 (sometimes modified or stale) is shipped with the malware binary and installed on a client 110, or Tor2Web is used. Tor2web is a service that allows users to access HS without installing the Tor OP 115.

The threat model of Tor assumes a partial-view active adversary, who can control or view parts of the network 100, and generate, edit or delay traffic. If an attacker monitors both ends of a circuit (OP 115 to entry guard 132 and exit 136 to destination 120), the attacker will be able to link the source to the destination 120 using traffic or timing analysis and thereby break anonymity. A dangerous class of traffic analysis attacks known as Website Fingerprinting (WF) challenges this traditional threat model as WF only requires the attacker to be present between the OP 115 and the entry guard 132. FIG. 1 illustrates the point 140 where traffic analysis and WF is carried out in Tor. By analyzing the encrypted traffic, the attacker is able to identify the visited page and link the client 110 to the destination 120 for one or more cells.

Traffic analysis, and specifically WF, is carried out as follows. First, the attacker visits target pages using Tor and collects network traces. Next, the attacker extracts distinguishing features (such as the sequences of packets or timings between packets or bursts, etc.) and uses the distinguishing features to train a supervised classifier. Later, when the victim visits a page, the attacker uses the trained model to classify the traces to a website. In the present disclosure, the same approach may be used to collect traffic of various malware binaries and benign browsing sessions to generate groundtruths for training a classifier to identify malware binaries, even those never previously seen by the classifier and without having to decrypt the analyzed traffic.

Approaches relying on IP or domain blacklisting to identify malicious traffic are irrelevant as the destination IP address or domain appears as a benign entry guard 132 for both benign and malicious Tor connections. Even if malware establishes multiple TCP streams, Tor often multiplexes these streams in a single circuit, which is in turn multiplexed with other circuits in one TCP connection, so the frequency of the malicious connections is very unlikely to raise any alarms. Finally, approaches relying on DNS resolution (or records) features alone are not expected to be useful in identifying malicious connections, as Tor usually resolves DNS within the network.

In contrast, the detection system 150 described herein performs malware detection at the client network side. This approach allows a network administrator, who has access to network and traffic logs, to identify local infections effectively.

For the detection system 150 to work effectively in the real world, the detection system includes a classifier 155 that is trained on benign traffic covering various client applications as well as malicious traffic.

In various embodiments, automatic malware tagging tools are to categorize binaries into malware families and classes. Family labels are common names that security companies use to identify specific malware threats (e.g., zeus, agentb, wannacry etc.). Class labels are generic labels that define the malware type, such as worms, trojans, hacking tools, ransomeware, and others. Family labels are more specific, while class labels are more generic and are assigned by AV engines that may not have coverage for specific families or that fail to correctly label the binaries. A binary can have one or more classes based on the behavior of that binary. The similarity in benign and malware traffic makes for representative experimental datasets that reflect real traffic captures with higher chances of malware traffic blending into benign.

In various embodiments, the classifier is trained on the categories listed in Table 1, although the present disclosure contemplates that some of these categories may be omitted and that other categories may be introduced.

TABLE 1

| Category | Category-based Features |
|---|---|
| Duration | +Average/shortest/longest duration connection |
| | +Number of short duration connections (<=1 minute) |
| | +Average duration between each Tor connection |
| Data | +Mean/median/mode of total data exchanged |
| | +Mean/median/mode of total data sent/received |
| | +Mean/median/mode of total packets sent/received |
| Port | +Number of unique DST ports used across connections |
| | +Most frequent DST port used across Tor connections |
| | +Number of non-standard DST ports seen |
| | +Most frequent non-standard DST port |
| Connection | +Number of connections seen (per host or PCAP) |
| | +Number of failed or rejected attempts |
| | +Number of connections per second |
| | +Number of failed attempts per second |
| Domain Name | +Number of DNS queries rcode_name: REFUSED |
| Service (DNS) | +Number of DNS queries rcode_name: SERVFAIL |
| | +Number of URLs seen using “consensus” keyword |
| | +Number of URLs with “\tor” keyword |
| | +Number of DNS queries rcode_name: NXDOMAINS |
| | +Total Number of leaked onion domains |
| | +Number of unique onion domains leaked |
| | +Number of 'rejected' onion domain queries |

The classifier 155 of the present disclosure extracts WF features for the top N (e.g., three) active Tor connections per Packet Capture (PCAP). Novel features used to capture malware behavior that may be exposed by analyzing all Tor connections initiated by a host, including failed and less active connections at a host level (or PCAP). This set consists of 40 generic features in total with 22 novel features that capture Tor-based malware activity as listed in Table 1.

Malware attempts to connect to C&C are better captured by looking at the number of short-lived Tor connections seen on a host in the event of failed attempts, the frequency with which these attempts are made, and the corresponding DNS activity. The duration features include average duration of all Tor connections and other related statistics such as the minimum and maximum durations of connections, and the number of short duration (<=1 minute, or another threshold) connections seen in a PCAP. To capture the frequency of connections, the classifier 155 uses features such as the number of Tor connections per PCAP, number of failed connection attempts, number of connections per second and number of failed attempts per second. We used the average time gap (in seconds) between each Tor connection as a feature to capture unusual connection patterns.

It is possible that a malware may fail to use Tor successfully to contact its destination. In such cases, the malware may use other methods to access an associated HS such as via Tor2Web. Doing so can lead to onion domain leaks in the DNS activity of an infected client 110. Moreover, some malware families are known to contact kill switch domains (onion sites hard coded in the binary), which signal the malware to execute certain operations. WarmaCry, for instance, uses a failed response from a kill switch domain as a signal to spread to other machines in the network. These scenarios are captured with DNS features such as number of DNS queries with a ‘REFUSED’. ‘SERVFAIL’ or ‘NXDOMAIN’ response, number of onion domain leaks, number of unique onion domains leaked and rejected onion domain queries

Additionally, the classifier 155 uses features such as the number of destination ports seen in a PCAP across all Tor connections, number of unique DST (destination)ports seen, most frequently used DST (destination) ports, and number of HTTP URLs accessing sites with keyword ‘consensus’ or ‘\tor’ to capture such activities. Finally, the classifier 155 uses statistical features such as the mean, median and mode of the total data sent and received and packets exchanged across all Tor connections,

Differences between benign and malicious Tor traffic arise from server traffic fingerprints (e.g., patterns, burstiness, lifetime of connections, frequency, etc.) and client-side anomalies. Connection-level features effectively fingerprint specific servers and their pages, while host-level features are computed at the PCAP-level and capture client-side anomalies such as short-lived, and sometimes failed connections due to trying stale routers (IPs no longer in Tor consensus).

The detection system 150, in addition to using conn. log and ssl. log for extracting connections, also may use dns. log and http. log fields for feature engineering. Once Tor connections are extracted from PCAPs and verified in the pipeline, the detection system 150 parses the corresponding connection packets for Tor cells. Tor embeds application data into Tor cells of size 514 bytes. The detection system 150 follows the standard parsing methodology. The detection system 150 considers the length of the TLS application record, rounds the record to the closest multiple of 514, and divide the record by 514 (the size of one Tor cell unit). For instance, a TLS record of length 1,088 results in 2 cells, while a TLS record of 1,090 also results in two cells. If this record belongs to an incoming packet, the record is marked as negative, otherwise the record is marked as positive. The signs (positive/negative) indicate the direction of flow.

Each PCAP may contain one or more Tor connections, each of which is parsed, and stored in cell files as described (e.g., using Python's dpkt library). Each line in a cell file corresponds to a single cell with associated time and direction information. The time is calculated relative to the timestamp of the first packet of a Tor connection, By the end, the detection system 150 has a cell file, which consists of cells corresponding to top N most active Tor connections for each PCAP (in terms of number of cells). Note that some PCAPs may have fewer than three active Tor connections.

The datasets used to train the detection system 150 may include real-world traffic or generated/simulated traffic.

The classifier 155 may be evaluated based on metrics of: Precision, Recall, and the False Positive Rate (FPR). Precision measures the ratio of correct positive class predictions among all positive predictions reported by the classifier 155, which defines how reliable model predictions are if the classifier 155 were to be used in a real system taking into account the number of false alarms. Recall measures the ability of the classifier 155 to identify positive class samples from all actual positive samples. A classifier 155 with very low recall would miss most malware instances classifying them as benign, making false negatives high in this case. Finally, the FPR is indicates the amount of benign samples identified as malicious, and the goal of classifier 155 is to keep the FPR as low as possible so as not to overwhelm network administrative users with the rate of false alarms.

Various tools may be used to train each classifier 155 iteratively using random stratified splits of data for training and validation with different hyperparameters in each run, During training, the tools try to optimize model performances on validation data based on one or more metrics to strike a good balance between precision and recall while maintaining a low FPR. At the end of the training phase. For example, tools may use Light Gradient Boosting Machine (LightGBM), CatBoost, XGBoost, Random Forests, Extra Trees, kNN, Logistic Regression, and Tabular Neural Network models along with stacking and bagged ensembles of each to generate a trained classifier 155.

These results indicate that high-level information extracted using all Tor connections in a PCAP can be effective in capturing and classifying malware behavior than when activity in only the most active connections is considered This is particular useful since most enterprise logs have these readily captured as opposed to packet capture logs needed for connection-level features.

As intended, these features leverage peculiar differences in duration of malware versus benign traffic, which is not captured at the connection-level. Other top-performing features include the number of unique DST ports used across Tor connections, which reflect distinguishable patterns in the variety of ports used in malware compared to benign traffic. Other features that make up the top ten ranked features include statistical mean, median and mode of data sent and received in all Tor connections.

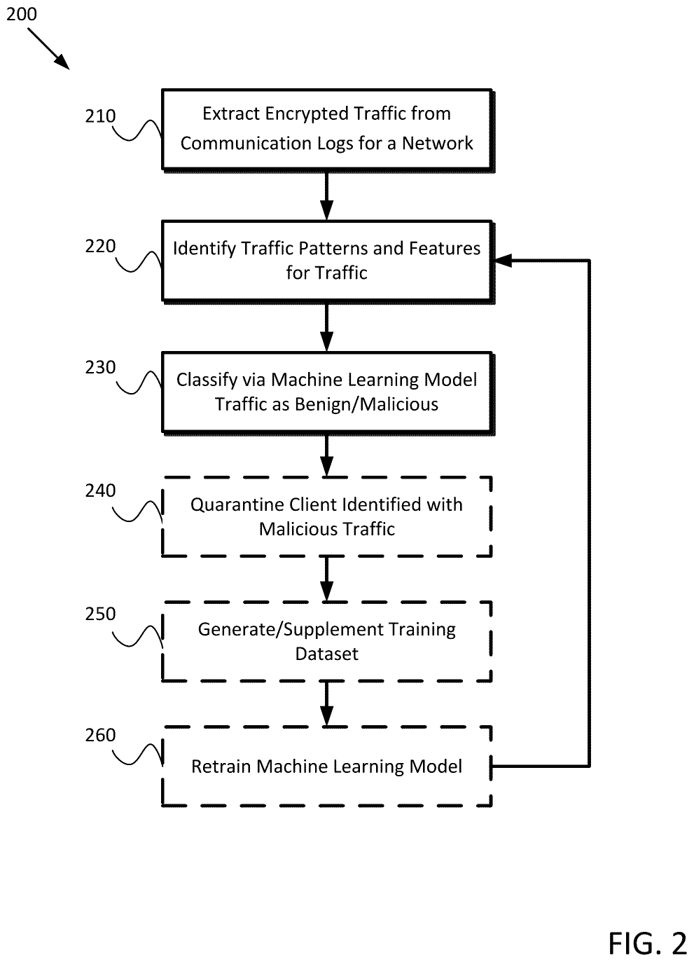

FIG. 2 is a flowchart of an example method 200 for Tor-based malware detection, according to embodiments of the present disclosure. Method 200 begins at block 210, where a detection system (as trained as described herein) extracts data related to encrypted traffic from communication logs for a network.

At block 220, the detection system identifies, from the encrypted traffic, while still encrypted, traffic patterns and features for users of the network.

At block 230, the detection system classifies, via a machine learning model, the encrypted traffic as benign traffic or malicious traffic without decrypting the encrypted traffic according to the traffic patterns identified.

At block 240, the detection system quarantines a computing device connected to the network that is associated with encrypted traffic identified as malicious.

At block 250, the detection system generates or supplements a training dataset based on the traffic patterns and classifications of the encrypted traffic as malicious or benign. In various embodiments, this dataset may be unlabeled, or an administrative user can review the findings of the classifier to label the data (e.g., indicating false positives).

At block 260, the dataset (e.g., generated or supplemented per block 250) is used to retraining the machine learning model used to classify traffic.

In some embodiments, the malicious traffic is cause by a zero-day malware (e.g., a hitherto unseen or unclassified malicious software package or agent) operating on a computing device connected to the network. Accordingly, the trained machine learning model may be used to identify malware based on the patterns of communications used by the malware, and not the contents of the client device hosting the malware. The present disclosure thereby allows network administrators to improve network security (e.g., against new threats) and devices not under direct control of the network (e.g., to quarantine “guest” devices connected to a local network).

FIG. 3 illustrates a computing device 300, as may be used for Tor-based malware detection, according to embodiments of the present disclosure. The computing device 300 may include at least one processor 310, a memory 320, and a communication interface 330.

The processor 310 may be any processing unit capable of performing the operations and procedures described in the present disclosure. In various embodiments, the processor 310 can represent a single processor, multiple processors, a processor with multiple cores, and combinations thereof.

The memory 320 is an apparatus that may be either volatile or non-volatile memory and may include RAM, flash, cache, disk drives, and other computer readable memory storage devices. Although shown as a single entity, the memory 320 may be divided into different memory storage elements such as RAM and one or more hard disk drives. As used herein, the memory 320 is an example of a device that includes computer-readable storage media, and is not to be interpreted as transmission media or signals per se.

As shown, the memory 320 includes various instructions that are executable by the processor 310 to provide an operating system 322 to manage various features of the computing device 300 and one or more programs 324 to provide various functionalities to users of the computing device 300, which include one or more of the features and functionalities described in the present disclosure. One of ordinary skill in the relevant art will recognize that different approaches can be taken in selecting or designing a program 324 to perform the operations described herein, including choice of programming language, the operating system 322 used by the computing device 300, and the architecture of the processor 310 and memory 320. Accordingly, the person of ordinary skill in the relevant art will be able to select or design an appropriate program 324 based on the details provided in the present disclosure.

The communication interface 330 facilitates communications between the computing device 300 and other devices, which may also be computing devices as described in relation to FIG. 3. In various embodiments, the communication interface 330 includes antennas for wireless communications and various wired communication ports. The computing device 300 may also include or be in communication, via the communication interface 330, one or more input devices (e.g., a keyboard, mouse, pen, touch input device, etc.) and one or more output devices (e.g., a display, speakers, a printer, etc.).

Although not explicitly shown in FIG. 3, it should be recognized that the computing device 300 may be connected to one or more public and/or private networks via appropriate network connections via the communication interface 330. It will also be recognized that software instructions may also be loaded into a non-transitory computer readable medium, such as the memory 320, from an appropriate storage medium or via wired or wireless means.

Accordingly, the computing device 300 is an example of a system that includes a processor 310 and a memory 320 that includes instructions that (when executed by the processor 310) perform various embodiments of the present disclosure. Similarly, the memory 320 is an apparatus that includes instructions that, when executed by a processor 310, perform various embodiments of the present disclosure.

Certain terms are used throughout the description and claims to refer to particular features or components. As one skilled in the art will appreciate, different persons may refer to the same feature or component by different names. This document does not intend to distinguish between components or features that differ in name but not function.

As used herein, the term “optimize” and variations thereof, is used in a sense understood by data scientists to refer to actions taken for continual improvement of a system relative to a goal. An optimized value will be understood to represent “near-best” value for a given reward framework, which may oscillate around a local maximum or a global maximum for a “best” value or set of values, which may change as the goal changes or as input conditions change. Accordingly, an optimal solution for a first goal at a given time may be suboptimal for a second goal at that time or suboptimal for the first goal at a later time.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

What is claimed is:

1. A method, comprising:
extracting encrypted traffic from communication logs for a network;
identifying, from the encrypted traffic, while still encrypted, traffic patterns for users of the network; and
classifying, via a machine learning model, the encrypted traffic as benign traffic or malicious traffic without decrypting the encrypted traffic according to the traffic patterns identified.

2. The method of claim 1, further comprising:
quarantining a computing device connected to the network that is associated with encrypted traffic identified as malicious.

3. The method of claim 1, further comprising:
generating or supplementing a training dataset based on the traffic patterns and classifications of the encrypted traffic as malicious or benign.

4. The method of claim 3, wherein the training dataset includes labels provided from an administrative user for a correctness of the traffic patterns and classifications being identified as malicious or benign by the machine learning model.

5. The method of claim 3, further comprising:
retraining the machine learning model via the training dataset.

6. The method of claim 1, wherein the malicious traffic is cause by a zero-day malware operating on a computing device connected to the network.

7. The method of claim 1, wherein the machine learning model classifies the encrypted traffic as benign traffic or malicious traffic using features consisting of:
duration features, including at least one of:
an average, shortest, or longest duration connection,
a number of short duration connections less than 1 minute, and
an average duration between each Tor connection;
data features, including at least one of:
a mean, median, or mode of total data exchanged,
a mean, median, or mode of total data sent or received, and
a mean, median, or mode of total packets sent or received;
port features, including at least one of:
a number of unique destination ports used across connections,
a most frequent destination port used across Tor connections,
a number of non-standard DST ports seen, and
a most frequent non-standard DST port;
connection features, including at least one of:
a number of connections seen (per host or PCAP),
a number of failed or rejected attempts,
a number of connections per second, and
a number of failed attempts per second; and
Domain Name Service (DNS) features, including at least one of:
a number of DNS queries with rcode_name: REFUSED
a number of DNS queries with rcode_name: SERVFAIL
a number of uniform resource locators (URLs) seen using “consensus” keyword,
a number of URLs with “\tor” keyword,
a number of DNS queries rcode_name: NXDOMAINS,
a total Number of leaked onion domains,
a number of unique onion domains leaked, and
a number of ‘rejected’ onion domain queries.

8. A system, comprising:
a processor; and
a memory, including instructions, that when executed by the processor, perform operations that include:
extracting encrypted traffic from communication logs fora network;
identifying, from the encrypted traffic, while still encrypted, traffic patterns for users of the network; and
classifying, via a machine learning model, the encrypted traffic as benign traffic or malicious traffic without decrypting the encrypted traffic according to the traffic patterns identified.

9. The system of claim 8, the operations further comprising:
quarantining a computing device connected to the network that is associated with encrypted traffic identified as malicious.

10. The system of claim 8, the operations further comprising:
generating or supplementing a training dataset based on the traffic patterns and classifications of the encrypted traffic as malicious or benign.

11. The system of claim 10, wherein the training dataset includes labels provided from an administrative user for a correctness of the traffic patterns and classifications being identified as malicious or benign by the machine learning model.

12. The system of claim 10, further comprising:
retraining the machine learning model via the training dataset.

13. The system of claim 8, wherein the malicious traffic is cause by a zero-day malware operating on a computing device connected to the network.

14. The system of claim 8, wherein the machine learning model classifies the encrypted traffic as benign traffic or malicious traffic using features consisting of:
duration features, including at least one of:
an average, shortest, or longest duration connection,
a number of short duration connections less than 1 minute, and
an average duration between each Tor connection;
data features, including at least one of:
a mean, median, or mode of total data exchanged,
a mean, median, or mode of total data sent or received, and
a mean, median, or mode of total packets sent or received;
port features, including at least one of:
a number of unique destination ports used across connections,
a most frequent destination port used across Tor connections,
a number of non-standard DST ports seen, and
a most frequent non-standard DST port;
connection features, including at least one of:
a number of connections seen (per host or PCAP),
a number of failed or rejected attempts,
a number of connections per second, and
a number of failed attempts per second; and
Domain Name Service (DNS) features, including at least one of:
a number of DNS queries with rcode_name: REFUSED
a number of DNS queries with rcode_name: SERVFAIL
a number of uniform resource locators (URLs) seen using “consensus” keyword,
a number of URLs with “\tor” keyword,
a number of DNS queries rcode_name: NXDOMAINS,
a total Number of leaked onion domains,
a number of unique onion domains leaked, and
a number of ‘rejected’ onion domain queries.

15. A non-transitory computer readable storage medium including instructions, that when executed by a processor perform operations, comprising:
extracting encrypted traffic from communication logs for a network;
identifying, from the encrypted traffic, while still encrypted, traffic patterns for users of the network; and
classifying, via a machine learning model, the encrypted traffic as benign traffic or malicious traffic without decrypting the encrypted traffic according to the traffic patterns identified.

16. The medium of claim 15, the operations further comprising:
quarantining a computing device connected to the network that is associated with encrypted traffic identified as malicious.

17. The medium of claim 15, the operations further comprising:
generating or supplementing a training dataset based on the traffic patterns and classifications of the encrypted traffic as malicious or benign.

18. The medium of claim 17, wherein the training dataset includes labels provided from an administrative user for a correctness of the traffic patterns and classifications being identified as malicious or benign by the machine learning model.

19. The medium of claim 17, further comprising:
retraining the machine learning model via the training dataset.

20. The medium of claim 15, wherein the malicious traffic is cause by a zero-day malware operating on a computing device connected to the network.
